(19) United States
(12) Patent Application Publication
(10) Pub. No.: US 2012/0137241 A1
(43) Pub. Date: May 31, 2012

(54) MEDICAL IMAGE DIAGNOSTIC APPARATUS AND OPERATION INFORMATION RECORDING APPARATUS

(75) Inventor: Hiroshi KUROSAWA, Nasushiobarashi (JP)

(73) Assignees: TOSHIBA MEDICAL SYSTEMS CORPORATION, OTAWARA-SHI (JP); KABUSHIKI KAISHA TOSHIBA, TOKYO (JP)

(21) Appl. No.: 13/365,761

(22) Filed: Feb. 3, 2012

Related U.S. Application Data
(63) Continuation of application No. PCT/JP2011/077317, filed on Nov. 28, 2011.

(30) Foreign Application Priority Data
Nov. 29, 2010 (JP) 2010-265712

(51) Int. Cl. G06F 3/048

(52) U.S. Cl. 715/771

(57) ABSTRACT

According to one embodiment, a medical image diagnostic apparatus includes a user operation input unit, operation information generation unit, and display unit. The user operation input unit accepts user operations for medical examinations. The operation information generation unit generates identification information of the input user operation in real time in response to the user operation input to the user operation input unit. The display unit displays the generated identification information and an information input column for the user operation on a screen image in real time.

### CROSS REFERENCE TO RELATED APPLICATIONS

This application is a Continuation Application of PCT Application No. PCT/JP2011/077317, filed Nov. 28, 2011 and based upon and claiming the benefit of priority from prior Japanese Patent Application No. 2010-265712, filed Nov. 29, 2010, the entire contents of all of which are incorporated herein by reference.

### FIELD

Embodiments described herein relate generally to a medical image diagnostic apparatus and operation information recording apparatus.

### BACKGROUND

Medical image diagnostic apparatuses are used in hospitals and the like. When a trouble has occurred in a medical image diagnostic apparatus, the user contacts a service person to request him or her to do repair at an installation location of the medical image diagnostic apparatus. The service person does repair by hearing a condition at the time of occurrence of the trouble. When the service person cannot do repair on site, he or she brings back information such as the hearing result from the user, operation logs of the medical image diagnostic apparatus, and the like, and conducts a detailed investigation. When the service person cannot go to the installation location of the medical image diagnostic apparatus, he or she cannot hear the condition at the time of occurrence of the trouble. Also, when the service person has taken time until he or she went to the installation location, he or she hardly reminds and understands the condition at the time of occurrence of the trouble.

### CITATION LIST

It is an object to provide a medical image diagnostic apparatus and operation information recording apparatus, which can accurately inform a condition at the time of occurrence of a trouble.

### BRIEF DESCRIPTION OF THE DRAWINGS

FIG. 1 is a schematic view showing a typical use scene of a medical image diagnostic apparatus according to an embodiment.

FIG. 2 is a block diagram showing principal functions of the medical image diagnostic apparatus according to the embodiment.

FIG. 3 is a view showing a list of user operations classified into layers by an operation information generation unit shown in FIG. 2.

FIG. 4 is a view showing an example of a display layout of a screen image displayed by a display unit shown in FIG. 2.

FIG. 5 is a view showing a display example of a user operation window displayed by the display unit shown in FIG. 2, and is a view showing a change in display range within the user operation window upon sliding of a slider in a scroll bar.

FIG. 6 is a view showing a display layout of a screen image displayed by the display unit shown in FIG. 2, that is, an example of a display layout required to improve the visibility.

FIG. 7 is a view showing a display layout of a screen image displayed by the display unit shown in FIG. 2, that is, a display example of only user operations of the first layer.

FIG. 8 is a view showing a display layout of a screen image displayed by the display unit shown in FIG. 2, that is, a display example of user operations up to the second layer.

FIG. 9 is a view showing a display layout of a screen image displayed by the display unit shown in FIG. 2, that is, a display example of user operations up to the third layer.

FIG. 10 is a view showing an example of an operation panel, which is displayed by the display unit shown in FIG. 2 and is required to re-display a trouble report.

FIG. 11 is a view showing a change in screen image at the time of operation of the operation panel shown in FIG. 10.

FIG. 12 is another view showing a change in screen image at the time of operation of the operation panel shown in FIG. 10.

### DETAILED DESCRIPTION

In general, according to one embodiment, a medical image diagnostic apparatus used in medical examinations including, a user operation input unit, a generation unit, and a display unit. The user operation input unit accepts user operations for the medical examinations. The generation unit generates identification information of the input user operation in real time in response to the user operation input to the user operation input unit. The display unit displays the generated identification information and an information input column for the user operation on a screen image in real time.

A medical image diagnostic apparatus and operation information recording apparatus according to an embodiment will be described in detail hereinafter with reference to the drawings.

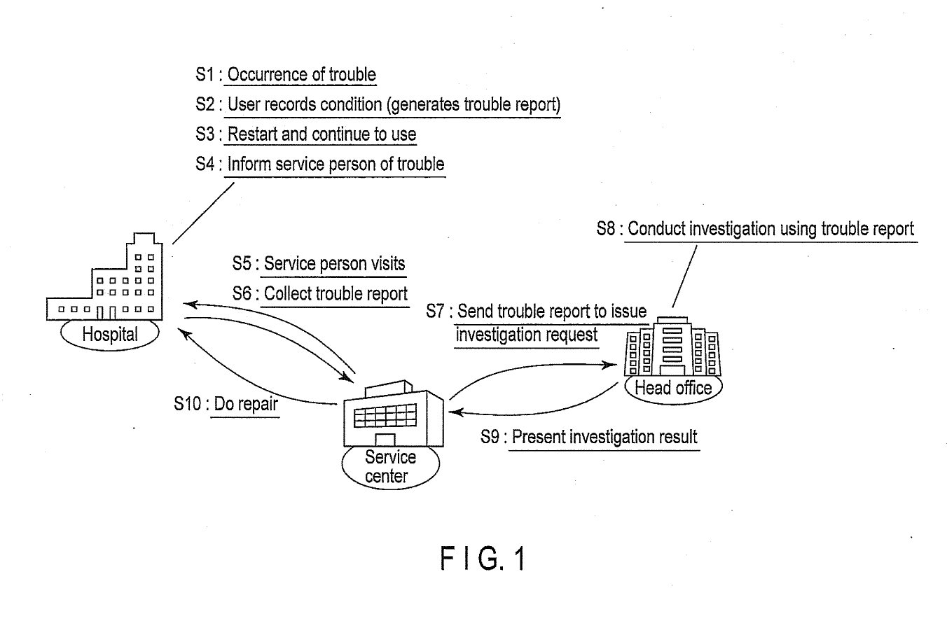

FIG. 1 is a schematic view showing a typical use scene of a medical image diagnostic apparatus according to an embodiment. Assume that the medical image diagnostic apparatus according to this embodiment is installed in a hospital. The medical image diagnostic apparatus according to this embodiment is applicable to every modality used in medical services such as an X-ray diagnostic apparatus, X-ray computed tomography apparatus, magnetic resonance imaging apparatus, ultrasonic diagnostic apparatus, and nuclear medicine diagnostic apparatus.

Assume that the user uses the medical image diagnostic apparatus according to this embodiment for medical examinations. Also, assume that a trouble associated with a user operation has occurred during use of the medical image diagnostic apparatus according to this embodiment (step S1). In this case, the medical image diagnostic apparatus records the trouble using trouble recording processing (to be described later) (step S2). As will be described later, a record which includes a user operation and information which records a condition of a trouble at the input timing of that user operation (to be referred to as trouble condition information hereinafter) will be referred to as a trouble report hereinafter.

This trouble report may also include time-series records of user operations (operation log information) before and after the record of the user operation, which records the trouble condition information, in addition to that record. The user restarts the medical image diagnostic apparatus and continues to use it (step S3). After completion of medical examinations, the user informs a service person at a service center of occurrence of the trouble (step S4). In response to the information from the user, the service person visits the hospital (step S5). The service person recovers a file of the trouble report generated in step S2 by writing it in, for example, a storage medium (step S6). The service person sends the file of the trouble report to a head office to issue an investigation request (step S7). Typically, the file of the trouble report is sent from the service center to the head office via a network. An engineer at the head office investigates the trouble using the trouble report (step S8). Then, the investigation result is presented from the head office to the service center (step S9). The service person visits the hospital and repairs the medical image diagnostic apparatus using the investigation result (step S10).

In this manner, the medical image diagnostic apparatus according to this embodiment can generate a trouble report which records a condition at the time of occurrence of a trouble in real time upon occurrence of the trouble. The arrangement of the medical image diagnostic apparatus according to this embodiment will be described below. This trouble report generation function is implemented by a computer incorporated in the medical image diagnostic apparatus. Note that this trouble report generation function is not limited to installation in the computer in the medical image diagnostic apparatus but it can be installed in every computer such as a work station.

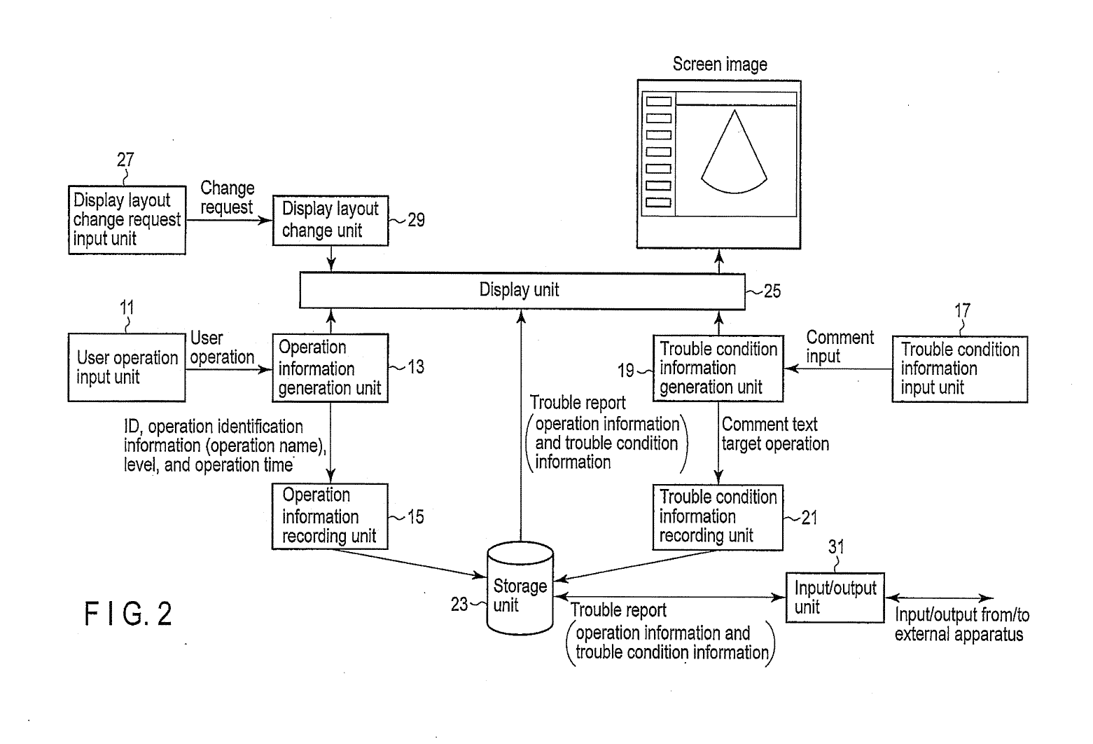

FIG. 2 is a block diagram showing principal functions of the medical image diagnostic apparatus according to this embodiment. As shown in FIG. 2, the medical image diagnostic apparatus according to this embodiment has a user operation input unit 11, operation information generation unit 13, operation information recording unit 15, trouble condition information input unit 17, trouble condition information generation unit 19, trouble condition information recording unit 21, storage unit 23, display unit 25, display layout change request input unit 27, display layout change unit 29, and input/output unit 31.

The user operation input unit 11 accepts various user operations (operation events) via an input device provided to the medical image diagnostic apparatus. An input signal of a user operation is supplied to the operation information generation unit 13. The user operations to be input include all operation events input via the input device in medical examinations using the medical image diagnostic apparatus. However, assume that the user operations do not include any input operations of comments (to be described later).

The operation information generation unit 13 generates operation information, which represents an attribute of the user operation input to the user operation input unit 11, in accordance with the input signal from the user operation input unit 11. The operation information includes a user operation ID, operation identification information used to identify contents of a user operation, an input time of the user operation (operation time), and a layer to which the user operation belongs. The user operation and operation identification information are associated in advance with each other using a table or the like. The operation information generation unit 13 generates operation identification information from a user operation input from the user operation input unit 11 using this table. More specifically, the operation identification information includes a title (operation name) which most clearly indicates contents of a user operation or an identifier of the title. Assume that the operation identification information is an operation name in the following description. A combination of the operation name and operation time is generally called an operation log (operation log information). Typically, the operation information generation unit 13 has a table which associates operation names with layers. The operation information generation unit 13 specifies a layer of a user operation input to the user operation input unit 11 using this table. The generated operation information is supplied to the operation information recording unit 15 and display unit 25.

A user operation of one type means, for example, processing by the medical image diagnostic apparatus, which is assigned to an input operation via an input device such as a button, switch, mouse, or trackball. All user operations belong to any of layers. Each layer means a detail level of a user operation. As a detail level is higher, a layer is higher. Conversely, as a detail level is lower, a layer is lower.

In the following description, user operations are managed while being classified into a plurality of layers, as described above. The number of layers of user operations is not particularly limited as long as it is two or more. Alternatively, user operations may not be classified into layers. Assume that user operations are classified into four layers, for the sake of the following description to be given specifically.

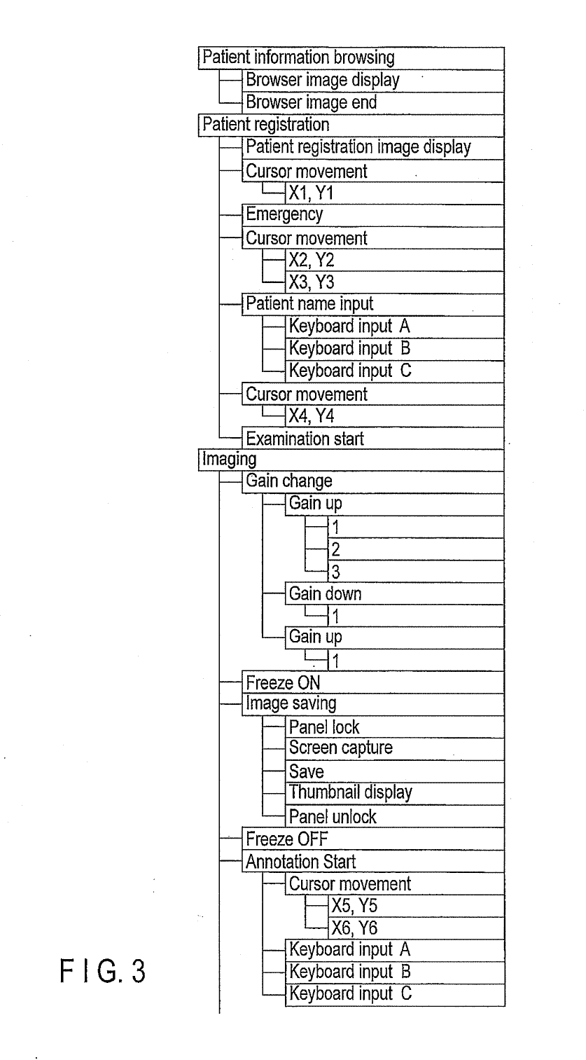

FIG. 3 shows a list of user operations classified into layers. As shown in FIG. 3, user operations which belong to the first layer include, for example, “patient information browsing” indicating the start of patient information browsing processing, “patient registration” indicating the start of patient registration processing, and “Imaging” indicating the start of imaging processing. Auxiliary operations of the user operations which belong to the first layer include user operations which belong to the second layer. For example, when the user operation of the first layer is “patient information”, user operations of the second layer include “browser image display” indicating the display disclosure of a browser image of patient information, and “browser image end” indicating the display end of the browser image. When the user operation of the first layer is “patient registration”, user operations of the second layer include “patient registration image display” indicating the display start of a patient information registration image, “cursor movement” indicating cursor movement, and “patient name input” indicating an input of a patient name. When the user operation of the first layer is “Imaging”, user operations of the second layer include “gain change” indicating a gain change, “image saving” indicating saving of an image, “annotation Start” indicating the input start of an annotation, and the like. The third layer includes auxiliary operations of the user operations which belong to the second layer. When the user operation of the second layer is “cursor movement”, a user operation of the third layer includes, for example, “X1, Y1” indicating coordinates of a cursor position. When the second layer is “patient name input”, user operations of the third layer include, for example, “keyboard input A”, “keyboard input B”, and “keyboard input C” indicating character inputs using a keyboard. When the second layer is “gain change”, user operations of the third layer include, for example, “gain up” indicating a gain up operation, and “gain down” indicating a gain down operation.

The operation information recording unit 15 records the operation information generated by the operation information generation unit 13 in the storage unit 23. Respective pieces of operation information are recorded in the order of operation times. Typically, operation identification information (operation name) is stored in the storage unit 23 in association with an operation time and layer.

The trouble condition information input unit 17 accepts an input operation of trouble condition information via the input device. An input signal of trouble condition information is supplied to the trouble condition information generation unit 19. The trouble condition information includes at least one of a character string (comment), mark, image, and option, each of which expresses a condition of a trouble of a user operation. A comment input method may include a text input method via a keyboard or an audio input method via a microphone or the like. The trouble condition information is input in association with a user operation.

The trouble condition information generation unit 19 generates a trouble condition information set based on the input signal of the trouble condition information from the trouble condition information input unit 17 every time a user operation is input via the trouble condition information input unit 17. The trouble condition information set includes a trouble condition information comment and a user operation ID corresponding to that trouble condition information. The trouble condition information set is supplied to the trouble condition information recording unit 21 and display unit 25.

The trouble condition information recording unit 21 records the trouble condition information set generated by the trouble condition information generation unit 19 in the storage unit 23. In this case, the trouble condition information recording unit 21 records the trouble condition information set in association with operation information associated with a corresponding user operation. Note that not all items in the trouble condition information set and those in operation information need be recorded in association with each other. At the very least, a trouble condition information comment and operation identification information (operation name) need only be recorded in association with each other. Such combination of the trouble condition information set and operation information configures a trouble report.

The storage unit 23 stores, as a trouble report, a trouble condition information set and operation information in association with each other. Note that such trouble report need not include all items in the trouble condition information set and those in the operation information. The trouble report need only include at least trouble condition information and an operation name. A file of the trouble report is generated in a predetermined unit such as a day unit, or an activation unit, session unit, or the like of the medical image diagnostic apparatus.

The display unit 25 displays an operation name generated by the operation information generation unit 13 and an input column of trouble information on a screen image in real time every time a user operation is input via the user operation input unit 11. Also, every time trouble condition information is input via the trouble condition information input unit 17, the display unit 25 displays an operation name of an input user operation and an input column of trouble information in association with the user operation. The trouble condition information and operation name are displayed to be visually associated with each other. Note that to display to be visually associated with each other is to display a trouble condition information and operation name in a layout that allows the user to easily understand that they are associated with each other when he or she views them. This layout will be described later. The display unit 25 can change a display layout under the control of the display layout change unit 29 (to be described later). Also, the display unit 25 can read out and display the previously generated trouble report from the storage unit 23 in response to an instruction input from the user via the input device.

The display layout change request input unit 27 accepts a display layout change request from the user via the input device. The change request is supplied to the display layout change unit 29. The change request includes, for example, a switching request of a user operation layer to be displayed. Another change request includes, for example, a change request of a display color or font of trouble condition information.

The display layout change unit 29 controls the display unit 25 to change a display layout in accordance with a change request input via the display layout change request input unit 27. For example, when a layer switching request is input, the display layout change unit 29 controls the display unit 25 to display operation names in a layer according to the request.

The input/output unit 31 writes a file of a trouble report, which is designated by the user via the input device from a file of at least one trouble report stored in the storage unit 23, in a storage medium (not shown) or the like in response to an instruction from the user via the input device. When the medical image diagnostic apparatus is connected to the service center or head office, the input/output unit 31 may send a file of a trouble report designated by the user to the service center or head office. Alternatively, the input/output unit 31 may read out a file of a trouble report from a storage medium or the like, and may write it in the storage unit 23. When the medical image diagnostic apparatus is connected to the service center or head office, the input/output unit 31 may receive a file of a trouble report from the service center or head office, and may write it in the storage unit 23.

An operation example of the medical image diagnostic apparatus according to this embodiment will be described below. A basic operation of this embodiment will be described first.

### First Embodiment

Assume that the medical image diagnostic apparatus according to this embodiment executes an application associated with medical examinations. The user inputs various user operations via the input device so as to conduct medical examinations. The medical image diagnostic apparatus executes processes corresponding to the input user operations.

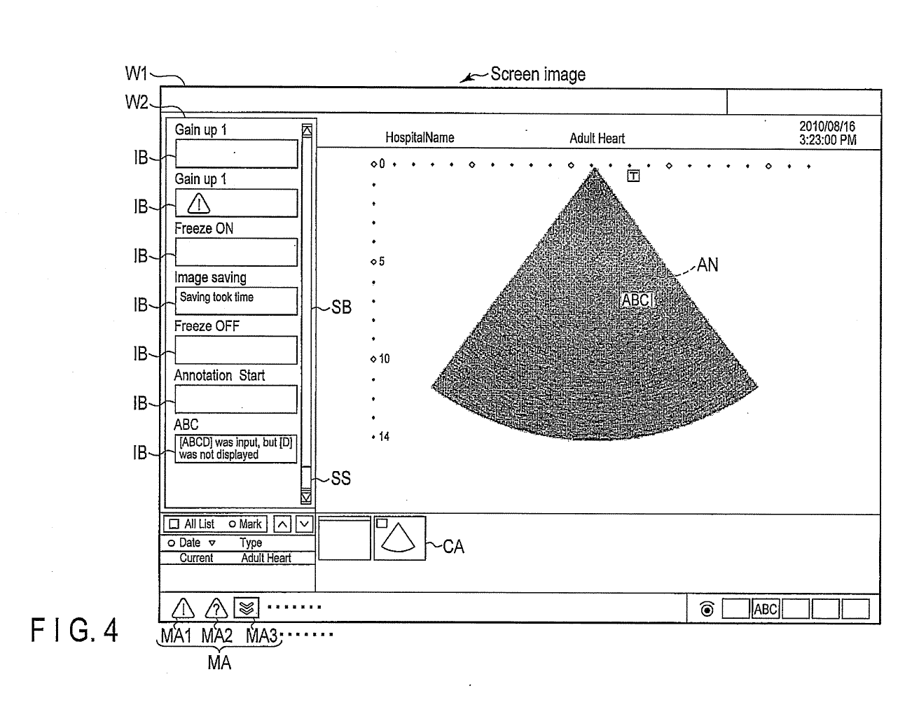

FIG. 4 shows an example of a display layout of a screen image displayed by the display unit 25 in medical examinations. As shown in FIG. 4, the screen image has a window W1 of a medical examination application (to be referred to as an application window hereinafter). Also, the screen image displays a window W2 of identification names of user operations according to this embodiment (to be referred to as a user operation window hereinafter). Note that the windows are implemented by, for example, displaying corresponding windows. For example, the user operation window W2 is displayed at an end portion (the left end in FIG. 4) on the screen image. On the user operation window W2, operation names and input columns IB of trouble condition information are displayed to be visually associated with each other. More specifically, each input column IB is displayed below a corresponding operation name. In this way, when the operation names and input columns IB are displayed to be visually associated with each other to meet a predetermined rule, the display unit 25 can display each operation name and a trouble condition information in the input column IB to be visually associated with each other.

Every time a user operation is input via the user operation input unit 11, the display unit 25 displays a set of an operation name of the input user operation and the input column IB on the user operation window W2 in real time. Typically, the set of the operation name of the latest user operation and input column IB is displayed below the already displayed sets.

Operation names displayed on the user operation window W2 in FIG. 4 include “gain up 1” indicating a gain up operation, “freeze ON” indicating an image freeze start operation, “image saving” indicating an image saving operation, “freeze OFF” indicating an image freeze end operation, annotation Start” indicating an annotation input start operation, “ABC” indicating that an annotation [ABC] is input, and the like.

In the input column IB, a trouble condition information input via the trouble condition information input unit 17 is displayed in real time. For example, assume that an image saving operation is input via the user operation input unit 11, but the saving operation takes time. In this case, the user can input a character string (comment) “saving took time” in the input column IB of the operation name “image saving”, for example, as shown in FIG. 4. This comment is recorded by the trouble condition information recording unit 21 in the storage unit 23 in association with the operation name “image saving”. Also, for example, assume that an input operation of an annotation “ABCD” is made via the user operation input unit 11, but only “ABC” is displayed, as shown in an annotation input column AN in FIG. 4. In this case, the user can input a comment “[ABCD] was input, but [D] was not displayed”. This comment is recorded by the trouble condition information recording unit 21 in the storage unit 23 in association with an identification name “ABC”. When the user wants to change a display color or font of a comment, he or she inputs a change request via the display layout change request input unit 27. The display layout change unit 29 controls the display unit 25 to display a comment using a display color or font according to the change request from the display layout change request input unit 27. When the comment is displayed using the display color or font desired by the user, the display unit 25 can display the comment clearly for the user.

On the screen image, a plurality of marks MA, which are prepared in advance, may be displayed as trouble condition information. Each mark MA is a GUI object which specifically indicates a condition of a trouble, which is predicted in advance. For example, marks MA1 and MA2 indicate occurrence of troubles. A mark MA3 indicates a low operation speed. These marks MA are displayed to be able to be dragged and dropped by a mouse or the like. The user selects a mark MA according to a trouble using, for example, the mouse, and drags and drops that mark in an input column IB corresponding to an operation name of a user operation which has caused the trouble. In this way, the mark MA is used as trouble condition information. Using the mark MA, steps required to input a character string can be saved.

As one of measures for saving character string input steps, a capture image CA of the screen image at the time of occurrence of a trouble may be placed in an input column IB. More specifically, when a trouble has occurred, the user inputs an instruction to generate a capture image of the screen image via the input device and the trouble condition information input unit 17. In response to this instruction, a capture image is generated by the trouble condition information generation unit 19. The generated capture image CA is displayed on the screen image. The capture image CA is displayed to be able to be dragged and dropped by the mouse or the like. The user selects the capture image CA, and drags and drops that image in an input column IB corresponding to an operation name of a user operation that has caused the trouble. In this way, the capture image CA is used as trouble condition information. Using the capture image CA, steps required to input a character string by the user can be saved. Also, using the capture image CA, a condition of the trouble, which is hardly reported by means of text, can be recorded in an easy-to-be-understood form. Note that the capture image CA is not limited to an image of the entire screen image, but it may be an image of a partial area of the screen image, which is selected by the user.

Although not shown, options such as radio buttons and check boxes may be displayed as trouble condition information in each input column IB. More specifically, character strings which indicate conditions of troubles, which are predicted in advance, and options may be displayed to be juxtaposed in an input column IB. The user selects an option corresponding to a trouble that has occurred, using the mouse or the like. Then, that option is used as trouble condition information. Using such options, steps required to input a character string can be saved.

When many user operations are input, and the user operation window W2 can no longer display all sets of operation names and input columns IB, operation names of older user operations and input columns IB are moved in turn to fall outside a display range of the user operation window W2. That is, the operation names of the older user operations and input columns IB are ceased to be displayed within the user operation window W2. In order to display operation names of arbitrary user operations and input columns IB, a scroll bar SB is laid out on the right end of the user operation window W2. A position of a slider SS in the scroll bar SB indicates that of the display range of the user operation window W2. According to a slide operation of the slider SS, the display unit 25 can display operation names and input columns IB (or comments in these input columns IB) laid out within the display range according to the position of the slider SS in the scroll bar SB.

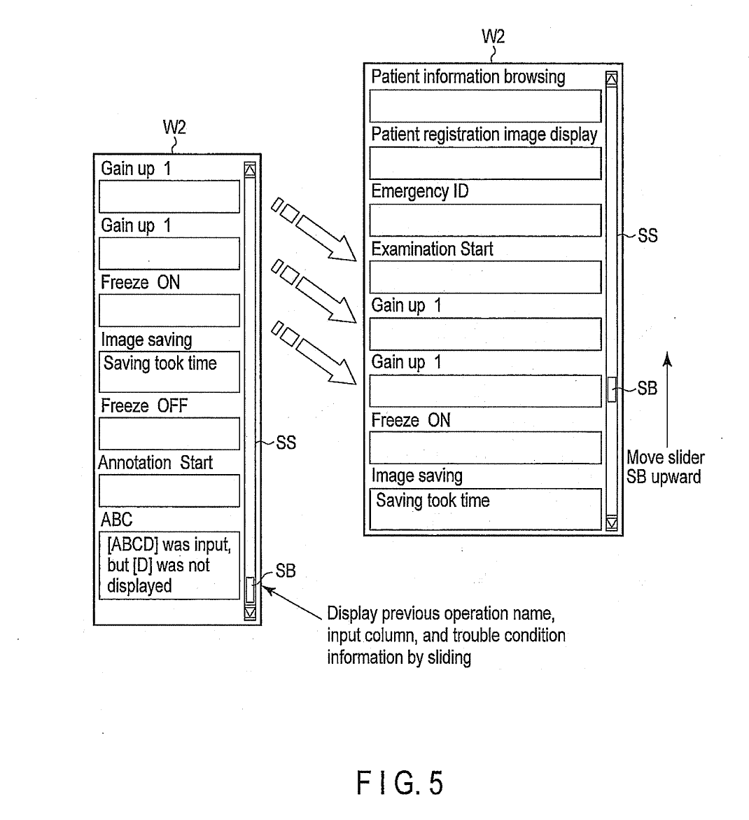

FIG. 5 shows a change in display range in the user operation window upon sliding of the slider SS in the scroll bar SB. In this case, the user slides the slider SS upward via the input device to a position where an operation name of a desired user operation and input column IB are laid out. Thus, the display unit 25 can display operation names of previous user operations and input columns SB, as shown in FIG. 5. Likewise, when the user slides the slider SS downward via the input device, operation names of newer user operations and input columns IB can be displayed.

Every time a user operation is input via the user operation input unit 11, an operation name, an operation time, and a layer of the input user operation are stored by the operation information recording unit 15 in the storage unit 23. Trouble condition information input to an input column IB is recorded by the trouble condition information recording unit 21 in the storage unit 23 in association with the operation name, operation time, and layer of the corresponding user operation. A set of a user operation ID, operation name, operation time, layer, and trouble condition information, which are associated with one user operation, forms one record of a trouble record. When no trouble condition information is input, a set of a user operation ID, operation name, operation time, and layer forms one record of a trouble report. For example, a set of all records which are recorded from the beginning to the end of one session of the user forms one trouble report. In this way, a trouble report is generated. A file of the trouble report has an identification name including a trouble report ID, a date and time of generation, and the like.

The file of the trouble report generated in this way is written in a storage medium by the input/output unit 31 in accordance with an instruction input by, for example, the service person via the input device. The service person or an engineer of the head office recognizes a condition of a trouble based on the trouble report to explore a reform measure. For example, the service person or engineer of the head office can investigate the reason why [D] was not displayed in the above example. In this case, the service person or engineer of the head office can understand that an input operation of [D] was not recorded by checking the comment “[ABCD] was input, but [D] was not displayed”, and the operation name “ABC”. Hence, the service person or engineer can predict that the user mistook that he or she input [D], or he or she pressed an input switch of [D] but that input signal was not output.

### Second Embodiment

On the user operation window W2 in FIG. 4, a plurality of operation names of user operations and input columns IB are displayed. Therefore, a case is assumed wherein a size of the user operation window W2, which occupies the screen image, becomes large, and an important image, characters, and the like in the application window W1 are hidden behind the user operation window W2. Therefore, when the user operation window W2 is displayed, the visibility of the screen image may drop.

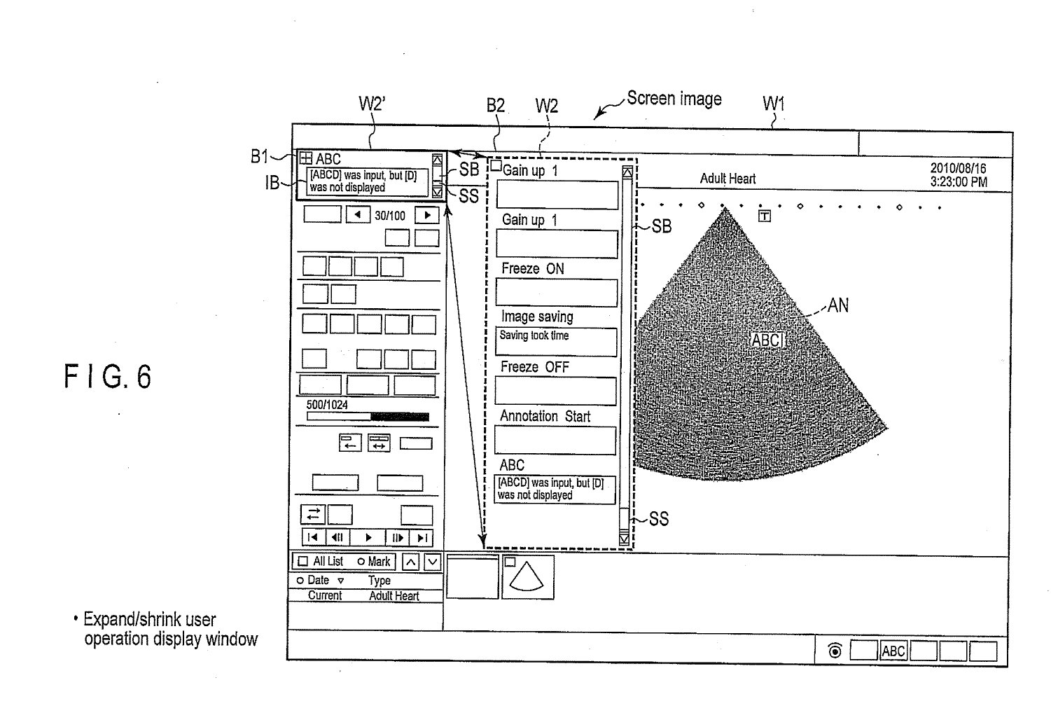

The display unit 25 according to the second embodiment displays the user operation window on the screen image to have a display layout that can eliminate a visibility drop compared to the first embodiment. FIG. 6 shows an example of a display layout required to improve the visibility of the screen image. Note that both, a user operation window W2′ and the user operation window W2 are shown for the sake of descriptive convenience, but both W2′ and W2 are never displayed at the same time in practice.

As shown in FIG. 6, the user operation window W2′ is displayed at a corner (for example, an upper left corner) of the screen image so as to improve the visibility of the screen image. The user operation window W2′ has only an area that can display an operation name of a user operation and an input column IB for one set. Typically, the latest user operation set is displayed on the user operation window W2′. Note that in case of the second embodiment, the display unit 25 can display a user operation set according to a position of the slider SS in the scroll bar SB in accordance with a slide operation of the slider SS in the scroll bar SB as in the first embodiment. By displaying such user operation window W2′ having a small area, the visibility of the screen image can be improved.

At predetermined positions (for example, left corners) of the user operation display areas W2′ and W2, size switching buttons B1 and B2 are laid out. The display unit 25 prepares for two types of user operation windows having different areas, that is, the first user operation window W2′ and second user operation window W2 as display layouts. Assume that the first user operation window W2′ has a displayable area for one set, and the second user operation window W2 has a displayable area for a plurality of sets as in the first embodiment. Upon pressing of the switching button B1, the first user operation window W2′ is switched to the second user operation window W2. Also, upon pressing of the switching button B2, the second user operation window W2 is switched to the first user operation window W2′. In this manner, pressing operations of the switching buttons B1 and B2 correspond to inputs of change requests of areas of the user operation windows by the display layout change request input unit 27.

Note that a design of the switching button B1 on the first user operation window W2′ may be different from that of the switching button B2 on the second user operation window W2. For example, the switching button B1 may be displayed as a “+” mark, and the switching button B2 may be displayed as a “−” mark. In this case, when the “+” mark B1 is pressed, the first user operation window W2′ is expanded to the second user operation window W2. After expansion, the “+” mark B1 is changed to the “−” mark B2. When the “−” mark B2 is pressed, the second user operation window W2 is shrunk to the first user operation window B2′. After shrinking, the “−” mark B1 is changed to the “+” mark B2.

By allowing to switch the area of the user operation window in this manner, a tradeoff relationship between the operability of a comment input and the visibility of the screen image can be eliminated.

### Third Embodiment

In the first embodiment, operation names associated with user operations of all layers are displayed. The display unit 25 according to the third embodiment displays operation names associated with user operations of selected layers.

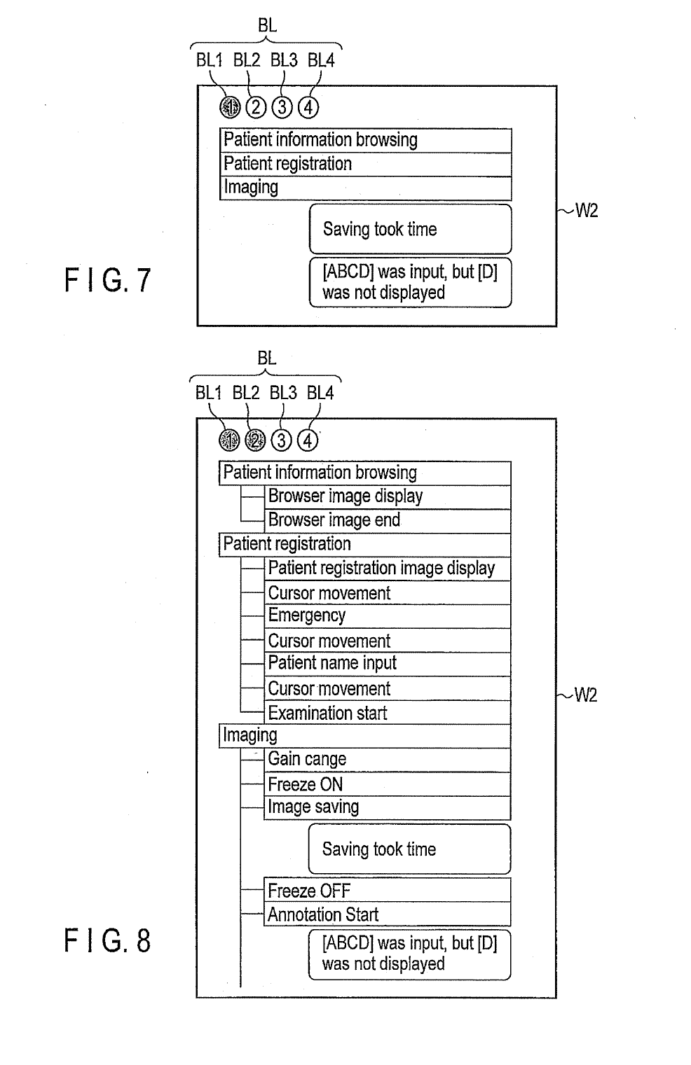

FIG. 7 shows a display example of only user operations of the first layer. As shown in FIG. 7, all user operations in the user operation window belong to one layer. In this case, since only operation names of user operations of the lowest detail level are displayed, the display unit can display only an overview of user operations. Note that an input column in which no comment is described is not shown. Whether or not to display each input column can be arbitrarily switched in accordance with an instruction from the display layout change request input unit via the user. Also, whether or not to display a comment can be arbitrarily switched in accordance with an instruction from the display layout change request input unit via the user.

FIG. 8 shows a display example of user operations up to the second layer. As shown in FIG. 8, user operations in the user operation window belong to the first or second layer. In this case, the display unit 25 can display operation names of user operations of two layers which are more specific than only one layer.

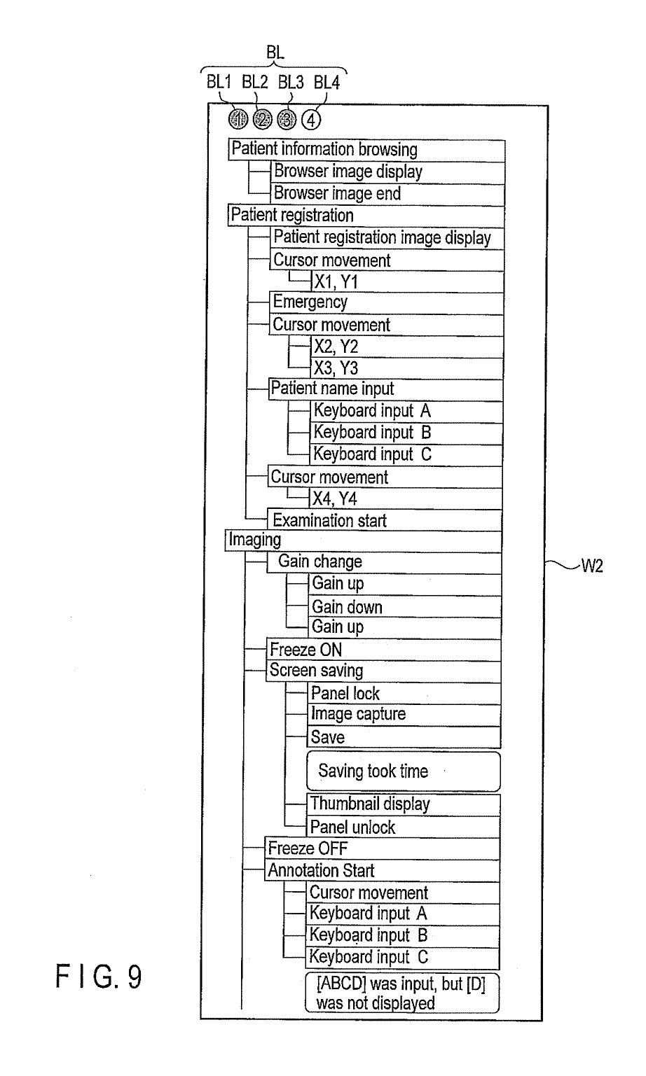

FIG. 9 shows a display example of user operations up to the third layer. As shown in FIG. 9, user operations in the user operation window belong to the first, second, or third layer. In this case, if the fourth layer is not required to be displayed in detail,. user operations up to the third layer need only be displayed.

As shown in FIGS. 7, 8, and 9, layer buttons BL used to select layers to be displayed are laid out on an upper portion of the user operation window W2. The layer buttons BL include a button BL1 used to display operation names up to the first layer, a button BL2 used to display operation names up to the second layer, a button BL3 used to display operation names up to the third layer, and a button BL4 used to display operation names up to the fourth layer. In response to a pressing operation of the button BL1, BL2, BL3, or BL4, operation names up to the layer corresponding to the pressed button are displayed on the user operation window W2. For example, upon pressing of the button B12, operation names of user operations of the first and second layers are displayed on the user operation window W2. A pressing operation of each button BL corresponds to an input of a change request of a display layer of the user operation window W2 by the display layout change request input unit 27. In this way, since operation names of user operations are selectable for respective layers, only required information can be specifically displayed according to each individual situation and user's favor. In case of layer-dependent display, the display unit 25 may display the buttons of displayed layers and those of non-displayed layers in different colors, so as to allow the user to clearly recognize the displayed layers and non-displayed layers.

### Fourth Embodiment

A medical image diagnostic apparatus according to this embodiment has a function of displaying a previous trouble report. Display processing of a previous trouble report will be described below.

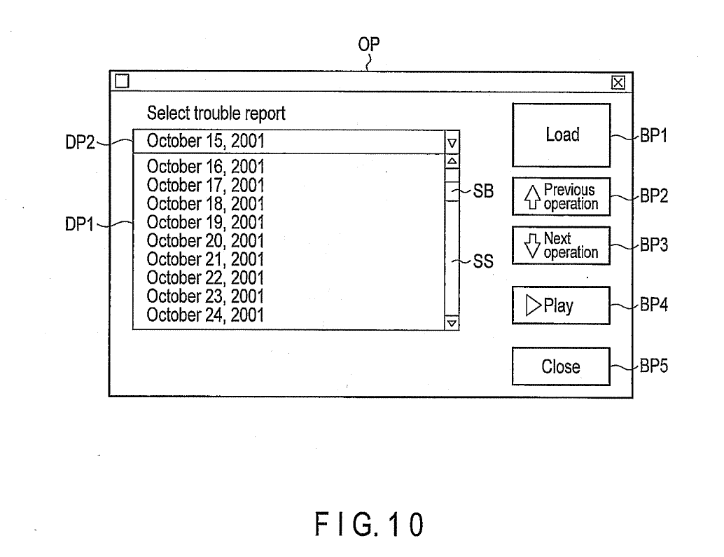

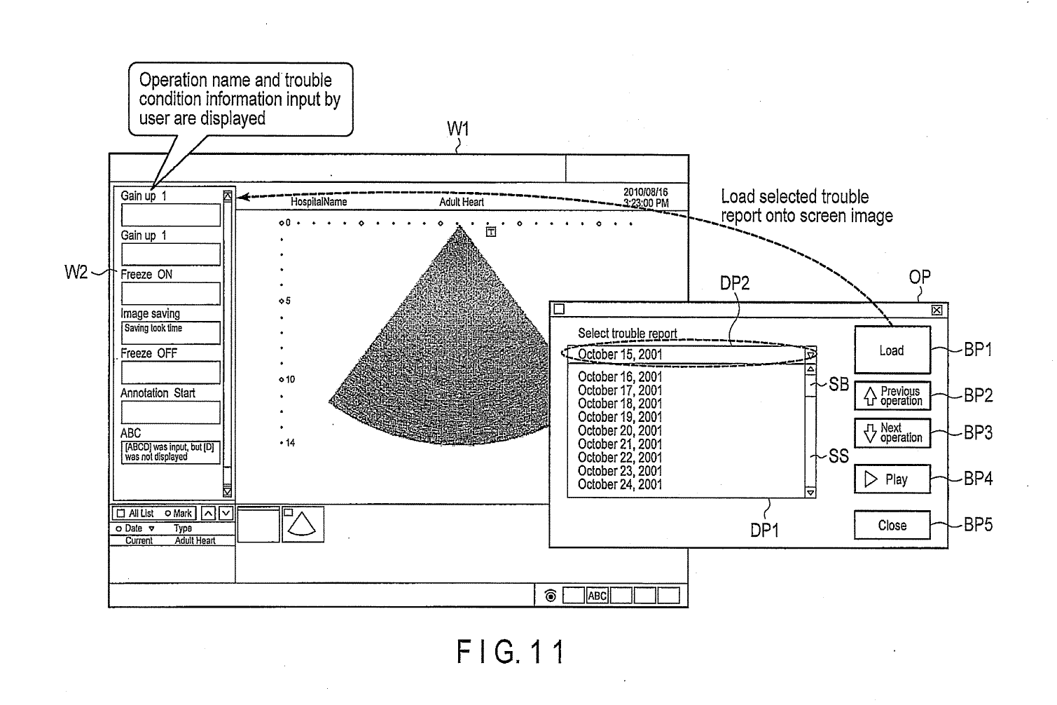

FIG. 10 shows an example of an operation panel OP, which is displayed by the display unit 25 and is required to re-display a trouble report. The display unit 25 displays the operation panel OP on the screen image when, for example, the user presses a panel display button laid out on the screen image or the like. As shown in FIG. 10, the operation panel OP has a list display area DP1 of trouble reports. On the list display area DP1, identification names of a plurality of trouble reports stored in the storage unit 23 or storage medium are displayed as a list. An identification name of a trouble report may use, for example, a date of generation of that trouble report, as shown in FIG. 10, or may use a name arbitrarily given by the user. In order to allow the user to easily specify a desired trouble report, the plurality of trouble reports may be displayed in the list display area DP1 while being sorted in a date order. The user can select an identification name of a desired trouble report from those of the plurality of trouble reports. The operation panel OP has a selected report display area DP2 on the upper portion of the list display area DP1. The selected report display area DP2 displays an identification name selected on the list display area DP1. In case of FIG. 10, a trouble report “Oct. 15, 2001” is selected.

Also, on the operation panel OP, a load button BP1 is laid out. When the load button BP1 is pressed while an identification name of a trouble report is selected from the list display area DP1, the display unit 25 reads out a file of the trouble report corresponding to the selected identification name from the storage unit 23 or storage medium, and displays the readout file. For example, when the user selects a trouble report “Oct. 15, 2001”, and presses the load button BP1, the selected trouble report “Oct. 15, 2001” is displayed on the user operation, display window, as shown in FIG. 11. That is, identification names of user operations included in the trouble report “Oct. 15, 2001” are reproduced. During display of the trouble report, the display unit 25 can change layers to be displayed, and can change a display color or font of each comment via the display layout change request unit 27, as described above.

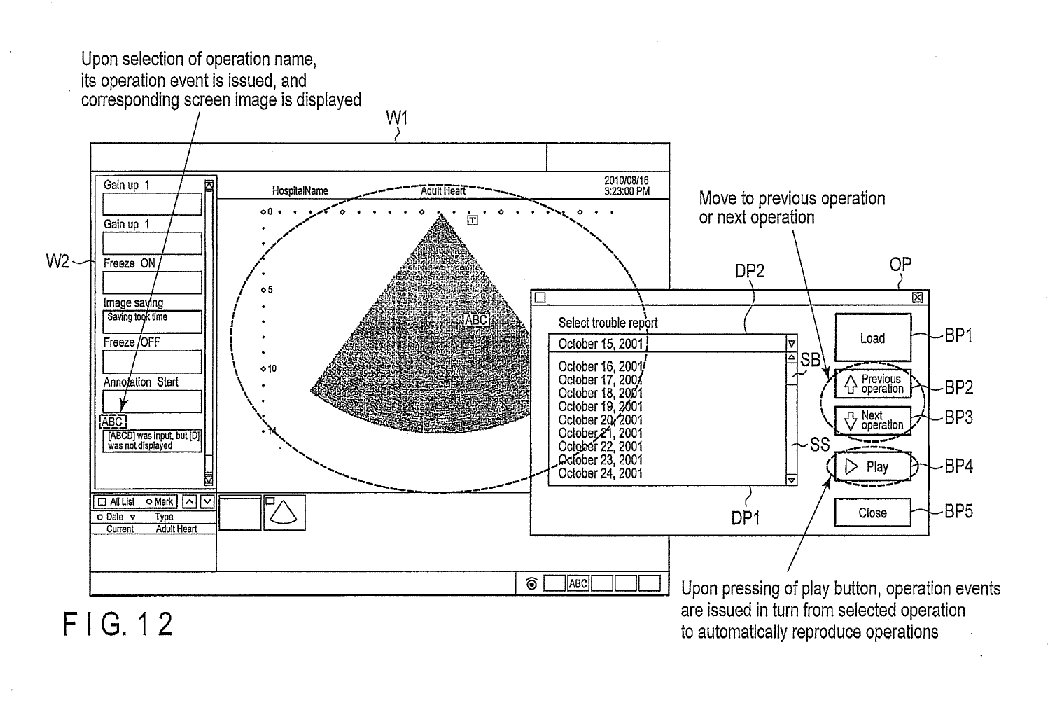

As shown in FIG. 12, when the user selects an operation name of a user operation included in the trouble report on the user operation window W2 via the input device, the selected user operation is reproduced on the screen image (an operation event is issued). For example, when the user selects an operation name “ABC” of a user operation associated with an input “ABC”, the display unit 25 displays “ABC” at an actual annotation input position AN.

As shown in FIGS. 10, 11, and 12, a “previous operation” button BP2 and “next operation” button BP3 are further laid out on the operation panel OP. When the user presses the “previous operation” button BP2, a user operation immediately before the selected user operation is selected. When the user presses the “next operation” button BP3, a user operation immediately after the selected user operation is selected. For example, when the user presses the “previous operation” button BP2 while a user operation “freeze OFF” is selected, a user operation “image saving” is selected; when he or she presses the “next operation” button BP3, a user operation “annotation Start” is selected. When the user newly selects a user operation, the newly selected user operation is reproduced on the screen image.

As shown in FIGS. 10, 11, and 12, a “play” button BP4 is further laid out on the operation panel OP. When the user presses the “play” button BP4, user operations are reproduced in turn from the selected user operation. Also, a “Close” button BP5 is laid out on the operation panel OP. When the user presses the “Close” button BP5, the operation panel OP is cleared from the screen image.

Based on the previous trouble report display function, the display unit 25 can display operation names of user operations and trouble condition information, and can reproduce a user operation at the time of occurrence of a trouble. Thus, the user can easily remember the condition at the time of occurrence of the trouble. A service person or engineer can easily recognize the condition at the time of occurrence of the trouble.

With the above arrangement, the medical image diagnostic apparatus according to this embodiment displays an operation name indicating contents of a user operation and an input column of trouble condition information on the screen image every time the user operation is generated. When the user operation has caused a trouble, trouble condition information t such as a character string which expresses a condition of the trouble can be input to the input column according to an instruction input from the user via the input device. In this manner, the trouble condition information and operation name are stored in association with each other. A set of the trouble condition information and operation name serves as a trouble report. As described above, the medical image diagnostic apparatus according to this embodiment can record trouble condition information in association with an operation name of a user operation immediately after occurrence of a trouble, that is, while the user has a clear memory. The user can make an input operation of trouble condition information and can associate an operation name with the trouble condition information without any service person. Based on the trouble report recorded in this way, the service person or engineer can obtain an accurate condition at the time of occurrence of the trouble, and can shorten a time required until problem solving.

As described above, the medical image diagnostic apparatus according to this embodiment can accurately inform a condition at the time of occurrence of a trouble.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image diagnostic apparatus used in medical examinations, comprising:
a user operation input unit configured to accept user operations for the medical examinations;
a generation unit configured to generate identification information of the input user operation in real time in response to the user operation input to the user operation input unit; and
a display unit configured to display the generated identification information and an information input column for the user operation on a screen image in real time.

2. The medical image diagnostic apparatus according to claim 1, further comprising:
a trouble information input unit configured to input trouble information associated with the input user operation in accordance with an instruction from a user,
wherein the display unit displays the input trouble information in the information input column.

3. The medical image diagnostic apparatus according to claim 2, wherein every time the user operation is input to the user operation input unit, the display unit displays identification information of the input user operation and the information input column in association with the input user operation.

4. The medical image diagnostic apparatus according to claim 2, further comprising:
a storage unit configured to store the input trouble information and the generated identification information in association with each other.

5. The medical image diagnostic apparatus according to claim 4, wherein the display unit reads out the trouble information and the identification information from the storage unit in response to an instruction from the user and displays the read out trouble information and identification information.

6. The medical image diagnostic apparatus according to claim 4, further comprising:
a write unit configured to read out the trouble information and the identification information from the storage unit in response to an instruction from the user and to write the trouble information and the identification information in a storage medium.

7. The medical image diagnostic apparatus according to claim 1, wherein the display unit displays the identification information in a layout according to an instruction from a user.

8. The medical image diagnostic apparatus according to claim 1, wherein the user operations belong to a plurality of layers depending on detail levels, and
the display unit displays identification information corresponding to the input user operation in a layer according to an instruction from a user of the plurality of layers.

9. The medical image diagnostic apparatus according to claim 1, wherein the identification information is a name or an identifier of the user operation.

10. The medical image diagnostic apparatus according to claim 1, wherein the trouble information includes at least one of a character string, a mark, an image, and an option, each of which expresses a condition of a trouble of the user operation.

11. The medical image diagnostic apparatus according to claim 1, wherein the display unit displays the generated identification information and the information input column on the screen image in real time together with a window of an application for the medical examinations.

12. A medical image diagnostic apparatus used in medical examinations, comprising:
a user operation input unit configured to accept user operations for the medical examinations;
a generation unit configured to generate identification information of the input user operation in real time in response to the user operation input to the user operation input unit;
a trouble information input unit configured to input trouble information associated with a condition of a trouble of the input user operation in accordance with an instruction from a user; and
a storage unit configured to store the generated identification information and the trouble information in association with each other.

13. An operation information recording apparatus comprising:
a user operation input unit configured to accept user operations;
a generation unit configured to generate identification information of the input user operation in real time in response to the user operation input to the user operation input unit;
a trouble information input unit configured to input trouble information associated with a condition of a trouble of the input user operation in accordance with an instruction from a user;
a storage unit configured to store the generated identification information and the input trouble information in association with each other for each user operation; and
a display unit configured to display the generated identification information and the input trouble information on a screen image in real time.
